(19) United States
(12) Patent Application Publication
(10) Pub. No.: US 2026/0264620 A1
(43) Pub. Date: Sep. 10, 2026

(54) CONSOLE FOR VEHICLE

(71) Applicants: Hyundai Motor Company, Seoul (KR); Kia Corporation, Seoul (KR); KBI DONGKOOK IND. CO., LTD., Seoul (KR)

(72) Inventors: Min Ha LEE, Hwaseong-Si (KR); Seok Ju GIM, Hwaseong-Si (KR); Chang Bok PARK, Hwaseong-si (KR); Jong Hyeon KIM, Hwaseong-si (KR)

(21) Appl. No.: 19/409,985

(22) Filed: Dec. 5, 2025

(30) Foreign Application Priority Data
Mar. 10, 2025 (KR) 10-2025-0030871

(51) Int. Cl. B60R 7/04; E05B 53/00

(52) U.S. Cl. CPC B60R 7/04; E05B 53/00

(57) ABSTRACT

Disclosed is a console for a vehicle. The console may include a console housing having a reception space in an interior of the console housing; a modular console detachably attached to the console housing and inserted into the reception space; a latch assembly that includes a push button movably affixed to the console housing, and a push rod configured to, based on being pushed down by the push button, be lowered; and a lift assembly provided in the interior of the console housing and disposed below the reception space. The lift assembly may be configured to, based on the push rod being lowered, elevate the modular console.

### CROSS-REFERENCE TO RELATED APPLICATION

This application claims the benefit of priority to Korean Patent Application No. 10-2025-0030871, filed in the Korean Intellectual Property Office on Mar. 10, 2025, the entire contents of which are incorporated herein by reference.

### TECHNICAL FIELD

The present disclosure relates to a console of a vehicle.

### BACKGROUND

A console of a vehicle may be used as an apparatus that is installed in a position that is easily approached by the driver in an interior of the vehicle to store articles or provide various functions. The console of a vehicle may be provided with, for example, a cup holder, a charging area for a smartphone, a charging port, one or more buttons, and various other convenience functions.

Vehicle consoles may be provided in a fixed form to provide convenience for drivers or passengers. For some of these vehicle consoles, for example, the entire panel of the vehicle may need to be replaced because they cannot be changed or replaced separately.

Thus, there exists an increasing need for a vehicle console that can be easily replaced, serviced, or customized.

The matters described in this Background section are only for enhancement of understanding of the background of the disclosure, and should not be taken as acknowledgement that they correspond to prior art already known to those skilled in the art.

### SUMMARY

The present disclosure has been made to solve the problems occurring in at least some implementations while advantages achieved by those implementations are maintained intact.

An aspect of the present disclosure provides a structure, by which a console module of a console of a vehicle may be easily replaced from a console housing, and a console of a vehicle, by which a console module may be elevated from the console housing.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a console of a vehicle may include: a console housing having a reception space in an interior of the console housing; a modular console detachably attached to the console housing and inserted into the reception space; a latch assembly including a push button movably affixed to the console housing, and a push rod configured to, based on being pushed down by the push button, be lowered; and a lift assembly provided in the interior of the console housing and disposed below the reception space. The lift assembly may be configured to, based on the push rod being lowered, elevate the modular console.

The lift assembly may include: a plate provided in the interior of the console housing; a first rail housing disposed below the plate and configured to elevate the plate; one or more first bearings provided on a side of the first rail housing and configured to roll with respect to the first rail housing; and one or more rods configured to rotate the one or more first bearings to elevate the first rail housing.

The lift assembly may further include: a second rail housing affixed to the console housing and disposed below the first rail housing; one or more second bearings provided on a side of the second rail housing and configured to roll with respect to the second rail housing; and an elastic guide affixed to the console housing and configured to rotate the one or more second bearings such that the one or more second bearings roll with respect to the second rail housing.

The one or more rods may include: a first rod including a first end portion affixed to the console housing to be rotatable, and a second end portion being rotatable with respect to the first end portion of the first rod to elevate the first rail housing; and a second rod including a first end portion extending to cross the first rod at a point and configured to slide with respect to the second rail housing, and a second end portion being rotatable with respect to the first end portion of the second rod and coupled to the plate.

The elastic guide may be further configured to elevate the second end portion of the second rod. The second rod may be configured to elevate the second end portion of the first rod.

The one or more first bearings may include a plurality of first bearings. The lift assembly may further include: a bearing connection plate connected to the plurality of first bearings; and a first rod connection shaft connecting the bearing connection plate to the first rod.

The one or more second bearings may include a plurality of second bearings. The lift assembly may further include: a second bearing connection plate connected to the plurality of second bearings; and a bracket connected to the second bearing connection plate and configured to affix the elastic guide.

The elastic guide may include: a first end portion affixed to the console housing and a second end portion affixed to the bracket. The elastic guide may include a leaf spring.

The lift assembly may further include: a second rod connection shaft connecting the second rod to the second bearing connection plate.

The lift assembly may further include: a locking boss coupled to be rotatable with the plate and configured to protrude upward from the plate to lock the modular console in place.

The modular console may include a modular console housing configured to be inserted into the reception space. The modular console housing may have a locking boss groove formed, on the modular console housing, to receive the locking boss.

The lift assembly may further include: a boss rotation shaft coupled to the locking boss such that the locking boss is rotatable with respect to the plate; and a coil spring disposed adjacent to the boss rotation shaft and configured to apply an elastic force to the locking boss.

The one or more rods may include a pair of first rods and a pair of second rods. Each of the pair of first rods may be provided to be spaced apart from and is parallel to a corresponding one of the pair of second rods. The lift assembly may further include: a first rod connection shaft connecting the pair of first rods; a second rod connection shaft connecting the pair of second rods; and a rod interference shaft connecting the pair of second rods at a point distinguished from the second rod connection shaft. The locking boss may further include: a first locking boss configured to be in contact with the first rod connection shaft; and a second locking boss spaced apart from the first locking boss and configured to be in contact with the rod interference shaft.

The latch assembly may further include: a latch configured to pass through the console housing to engage the plate and configured to move between a lock position, at which a position of the plate is fixed, and a release position, at which the push rod is lowered to disengage the latch from the plate.

The latch may further include: a latch body passing through the console housing; and a latch through-shaft protruding from the latch body and away from the console housing. The latch assembly may further include: a latch housing supported by the console housing having a hole through which the latch through-shaft passes.

The console housing may include a rod guide boss protruding to pass through the push rod. The push rod may have a rod through-hole through which the rod guide boss passes.

The lift assembly may further include: a pin connector passing through the plate to protrude toward the modular console. The modular console may include: a modular console housing configured to be inserted into the reception space and having a pin through-hole through which the pin connector passes; a pin contact configured to be connected to the pin connector; and a pin cover assembly affixed to the modular console housing and disposed between the pin contact and the pin connector. The pin cover may be configured to support the pin contact and cover the pin contact.

The pin cover assembly may include: a cover bracket affixed to the modular console housing and supporting the pin contact; and a pin cover configured to slide, with respect to the cover bracket, between: a first position, between the pin connector and the pin contact, at which the pin cover covers the pin contact, and a second position at which the pin contact is exposed through the pin through-hole.

The cover bracket may include: a bracket portion affixed to the modular console housing; a pin support portion protruding upward from the bracket portion and supporting the pin contact; and a boss guide portion protruding upward from the bracket portion and having a through-hole such that the pin cover is disposed between the boss guide portion and the pin support portion. The pin cover may include: a sliding cover portion configured to slide, while being guided by the bracket portion, to the first position to cover the pin contact; a sliding interference portion protruding upward from the sliding cover portion and configured to be in contact with the pin support portion; a sliding protrusion portion protruding from the sliding cover portion toward the sliding interference portion; and a guide boss portion protruding from the sliding protrusion portion to be inserted into the through-hole and configured to slide while being guided by the boss guide portion.

According to one or more example embodiments of the present disclosure, a vehicle may include a chassis and a console. The console may include: a console housing having a reception space in an interior of the console housing; a modular console detachably attached to the console housing and inserted into the reception space; a latch assembly including a push button movably affixed to the console housing, and a push rod configured to, based on being pushed down by the push button, be lowered; and a lift assembly provided in the interior of the console housing and disposed below the reception space. The lift assembly may be configured to, based on the push rod being lowered, elevate the modular console.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of an example vehicle console;

FIG. 2 is an exploded perspective view of an example vehicle console;

FIG. 3 is a set of enlarged views illustrating a process of moving a push rod and a guide stopper when a push button is actuated in an example vehicle console;

FIG. 4 is an enlarged view of a locking member, a stopper housing, a guide stopper, and a console housing;

FIG. 5 is a perspective view of an elevation module when an elevation plate is located in a first position;

FIG. 6 is a perspective view of an elevation module when an elevation plate is located in a second position;

FIG. 7 is a perspective view of an elevation module that is supported on a base plate;

FIG. 8 is a longitudinal cross-sectional view of a console of a vehicle when an elevation plate is located in a first position;

FIG. 9 is a longitudinal cross-sectional view of a console of a vehicle when an elevation plate is located in a second position;

FIG. 10 is a cross-sectional perspective view of a first locking boss, a first boss rotation shaft, an elevation plate, and a console module when the first locking boss is inserted into a locking boss groove;

FIG. 11 is a cross-sectional perspective view of a first boss rotation shaft, a coil spring member, an elevation plate, and a console module;

FIG. 12 is a perspective view of a console module;

FIG. 13 is a cross-sectional perspective view of a module base, a pin contact, and a pin cover part of a console module;

FIG. 14 is a perspective view of a console module;

FIG. 15 is a cross-sectional perspective view of a module base, a pin contact, and a pin cover part of a console module;

FIG. 16 is a perspective view of a console of a vehicle; and

FIG. 17 is a longitudinal cross-sectional view of a console of a vehicle.

### DETAILED DESCRIPTION

Hereinafter, one or more example embodiments of the present disclosure will be described in detail with reference to the accompanying drawings. In adding reference numerals to the components of the drawings, it should be noted that the same components have the same numerals as possible even when they are illustrated on different drawings. Furthermore, in describing the example embodiment(s) of the present disclosure, detailed descriptions associated with well-known functions or configurations may be omitted if they may make subject matters of the present disclosure unnecessarily obscure.

In describing components of example embodiment(s) of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

As described herein, the “X” direction (as indicated in the drawings) may correspond to a “backward” or “rearward” direction with respect to the vehicle. An object facing in direction “X” may be referred to as facing “backward.” An object located further along direction “X,” in relative terms, may be described as being “rear.” The opposite direction of direction “X” may be a “forward” direction with respect to the vehicle. For example, the forward direction may be the direction that a driver of the vehicle would be facing when seated in the vehicle and driving the vehicle. An object facing in the opposite direction of direction “X” may be referred to as facing “forward.” An object located further along the opposite direction of direction “X,” in relative terms, may be described as being “front.” A second direction (e.g., the “Y” direction as indicated in the drawings) may correspond to a rightward direction. An object facing in the second direction may be referred to as facing “right.” An object located further along the second direction, in relative terms, may be described as being “right.” The opposite direction of the second direction (e.g., the opposite direction of the “Y” direction as indicated in the drawings) may correspond to a leftward direction. An object facing in the opposite direction of the second direction may be referred to as facing “leftward.” An object located further along the opposite direction of the first direction, in relative terms, may be described as being “left.” A third direction (e.g., the “Z” direction as indicated in the drawings) may correspond to an upward direction. An object facing in the third direction may be referred to as facing “upward.” An object located further along the third direction, in relative terms, may be described as being “up” or “top.” The opposite direction of the third direction (e.g., the opposite direction of the “Z” direction as indicated in the drawings) may correspond to a “downward” direction. An object located further along the opposite direction of the third direction, in relative terms, may be described as being “down” or bottom.” Further, each of the first direction, the second direction, and the third direction may be perpendicular (e.g., orthogonal) to the remaining two directions. The first direction (or the opposite direction thereof) may be also referred to as the longitudinal direction or longitudinal orientation. The second direction (or the opposite direction thereof) may be also referred to as the lateral direction or lateral orientation. The third direction (or the opposite direction thereof) may be also referred to as the vertical direction or vertical orientation.

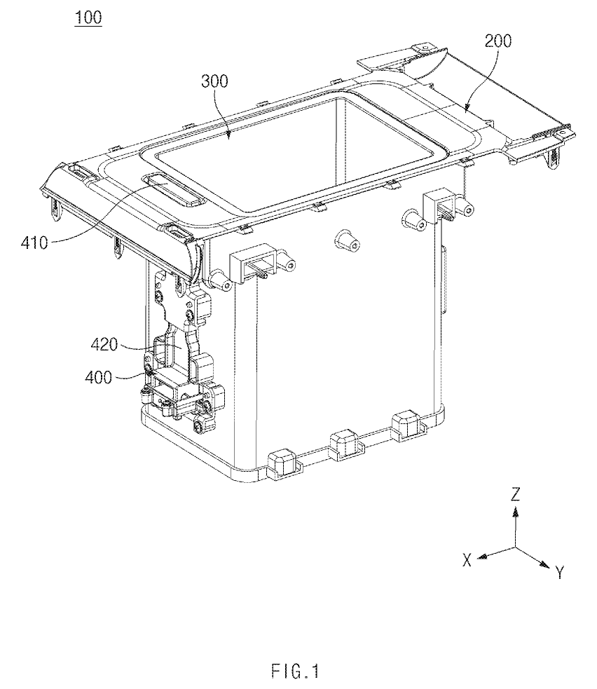

Hereinafter, one or more example embodiments of the present disclosure will be described in detail with reference to FIGS. 1 to 17.

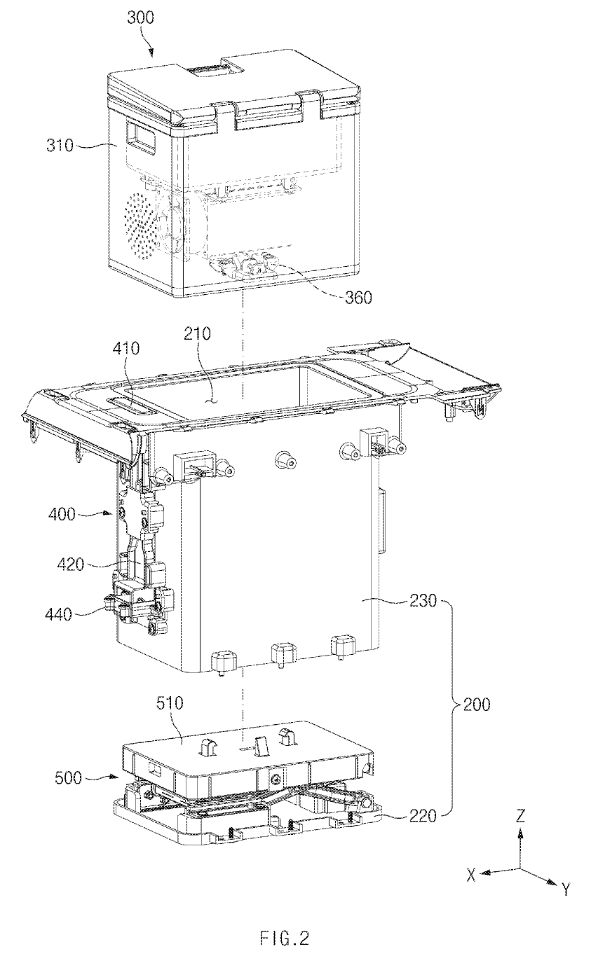

FIG. 1 is a perspective view of an example vehicle console of a vehicle. FIG. 2 is an exploded perspective view of an example vehicle console.

Referring to FIGS. 1 and 2, a console 100 for a vehicle may include a console housing 200 that is mounted on a vehicle, a console module (also referred to as a modular console) 300 that is detachably attached to the console housing 200, a guide module 400 that is mounted on the console housing 200, and an elevation module (also referred to as a lifting platform, a lift assembly, a lifting mechanism, a linear actuator, etc.) 500 that elevates the console module 300.

The console housing 200 may define a reception space 210. The console housing 200 may include a base plate 220, and a housing member 230 that is coupled to the base plate 220 to define the reception space 210.

The console module 300 (e.g., modular console) may be detachably attached to the console housing 200, and may be inserted into the reception space 210. The console module 300 may include a console module housing 310 that defines the exterior of the console module 300 and a pin cover part 360 that is provided in a lower area (in an opposite direction to the “Z” direction) of the console module housing 310.

The guide module 400 may be, for example, a latch assembly or a locking mechanism that keeps the console module 300 inside the console housing 200 (e.g., until it is released). The guide module 400 may include a push button (also referred to as button, release button, switch, press switch, etc.) 410 that passes through the console housing 200 and is movably supported by the console housing 200, and a push rod (also referred to as a locking rod or a release rod) 420 that interferes with (e.g., makes contact with, connects to, interacts with, etc.) the push button 410 and is lowered to an opposite side (an opposite direction to the “Z” direction) in the third direction as the push button 410 is pressed.

The elevation module 500 may be provided inside the console housing 200 and may be disposed on a lower side of the console module 300. The elevation module 500 may be supported by the base plate 220. The elevation module 500 may include an elevation plate 510 that elevates the console module 300 as the push rod 420 is lowered.

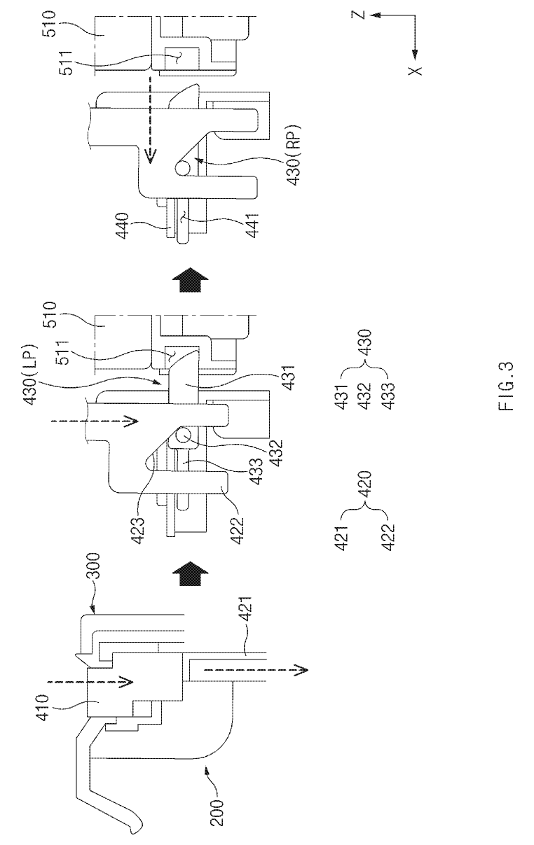

Herein, a principle of elevating the console module 300 by the guide module 400 and the elevation module 500 will be described in detail with reference to FIGS. 3 to 7.

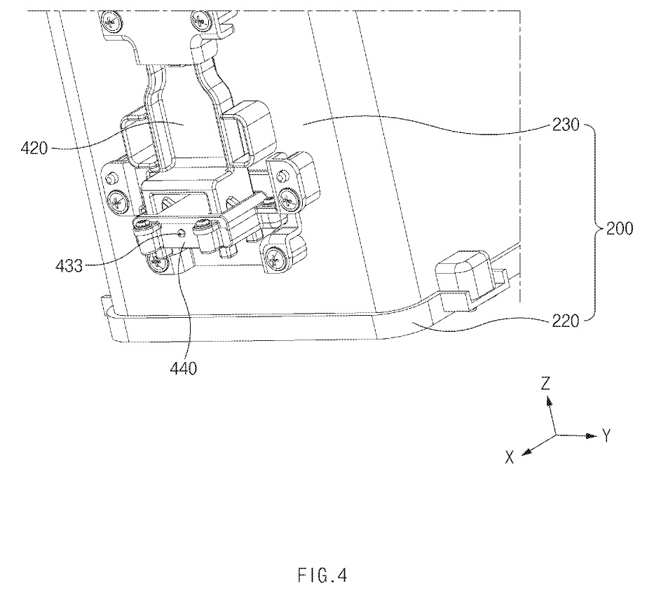

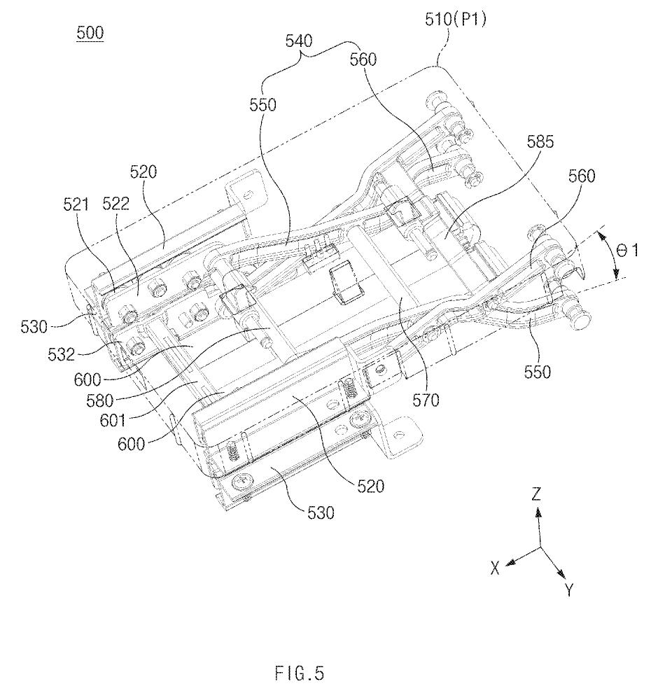

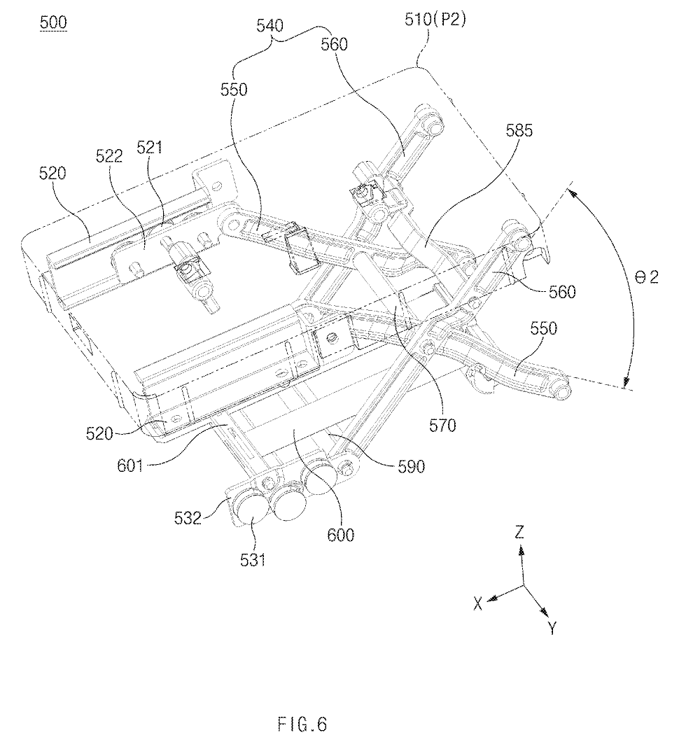

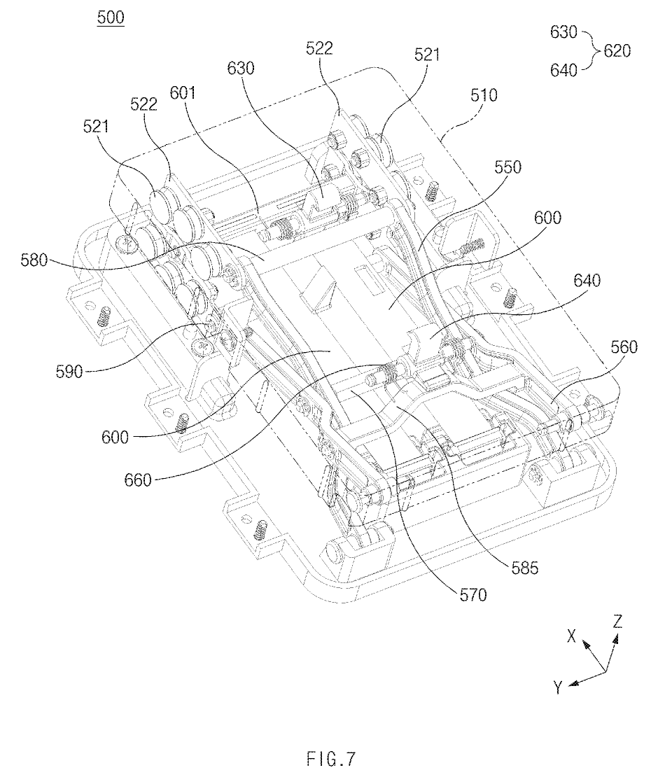

FIG. 3 is a set of enlarged views illustrating a process of moving a push rod and a guide stopper when a push button is actuated in an example vehicle console. FIG. 4 is an enlarged view of a locking member, a stopper housing, a guide stopper, and a console housing. FIG. 5 is a perspective view of an elevation module when an elevation plate is located in a first position. FIG. 6 is a perspective view of an elevation module when an elevation plate is located in a second position. FIG. 7 is a perspective view of an elevation module that is supported on a base plate.

Referring to FIGS. 3 to 7, the guide module 400 may further include a guide stopper 430 that may pass through the console housing 200 and interfere with (e.g., latch onto, engage, etc.) the elevation plate 510. The guide stopper 430 may be, for example, a latch (e.g., spring latch) or a catch.

The guide stopper 430 may be moved between a lock position LP, in which a position of the elevation plate 510 is fixed (e.g., affixed), and a release position RP, in which the push rod 420 is moved in a direction (e.g., moved down), in which the guide stopper 430 is extracted, to be released (e.g., disengaged) from interference with (e.g., from latching onto, from engaging, etc.) the elevation plate 510 as the push rod 420 is lowered.

More specifically, the guide stopper 430 may include a guide stopper body 431 that passes through the console housing 200, a guide stopper support shaft 432 that protrudes orthogonally from the guide stopper body 431 in two opposing directions (e.g., in the “Y” direction and in the opposite of the “Y” direction), and a guide stopper through-shaft 433 that protrudes from the guide stopper body 431 in a direction that becomes more distant from (e.g., away from) the console housing 200. The guide stopper support shaft 432 may be, for example, a pin. The pin may, for example, penetrate through the guide stopper body 431 and the guide stopper through-shaft 433 and keep them from being separated from each other.

The guide stopper body 431, for example, may be a latch. The guide stopper body 431 may pass through the console housing 200 and interfere with (e.g., lock, latch to, etc.) the elevation plate 510. When the guide stopper body 431 interferes with the elevation plate 510, the elevation plate 510 may be prevented from being elevated. When the guide stopper body 431 is extracted from the elevation plate 510, the elevation plate 510 may be in an elevatable state.

The elevation plate 510 may include a stopper groove 511 that is formed such that the guide stopper body 431 is inserted thereinto. The stopper groove 511 may have a shape that is concave toward one side of the elevation plate 510, which is adjacent to the guide stopper 430.

The push rod 420 may include one end portion 421 that interferes with the push button 410 and an opposite end portion 422 that contacts the guide stopper 430. The opposite end portion 422 of the push rod 420 may be disposed on a lower side (an opposite direction to the “Z” direction) of the one end portion 421 of the push rod 420.

The opposite end portion 422 of the push rod 420 may include a locking inclined surface 423 that extends at a specific angle with respect to a direction that faces the elevation plate 510 in a downward direction.

When the push rod 420 is pressed downward by the push button 410, the guide stopper 430 that contacts the locking inclined surface 423 may be moved in a direction that becomes more distant from the elevation plate 510.

When the guide stopper 430 becomes more distant from the elevation plate 510, the guide stopper body 431 may be extracted (e.g., unlatches) from the stopper groove 511.

Meanwhile, in order to guide the movement of the guide stopper 430 while the height of the guide stopper 430 is maintained, the guide module 400 may further include a stopper housing 440 that is supported by the console housing 200 and defines a stopper hole 441, through which the guide stopper through-shaft 433 passes.

The stopper housing 440 may accommodate the guide stopper 430 in an interior thereof, and the guide stopper through-shaft 433 may be exposed through the stopper hole 441. Accordingly, due to this structure, a position of the guide stopper 430 between the lock position LP and the release position RP may be identified from the outside.

In this way, in the release position RP of the guide stopper 430, the elevation plate 510 may be spaced apart from the guide stopper 430.

Referring to FIGS. 5 to 7, the elevation module 500 may include an elevation plate 510, a pair of elevation rail housings 520, a plurality of elevation bearings 521, a sliding rail housing 530, a plurality of sliding bearings 531, and an elevation rod 540.

The elevation plate 510 may be provided in an interior of the console housing 200 (see FIG. 2). The pair of elevation rail housings 520 may be disposed on a lower side of elevation plate 510 and may elevate the elevation plate 510. The plurality of elevation bearings 521 may be formed to roll with respect to each of the pair of elevation rail housings 520. The elevation rod 540 may be formed to elevate the elevation rail housings 520 by rotating the elevation bearings 521.

The elevation rail housings 520 may be coupled to the elevation plate 510. A plurality of elevation bearings 521 may be provided. For example, six elevation bearings 521 may be provided, and three of the six elevation bearings 521 may be provided on one side of any one of the pair of elevation rail housings 520. Three of the six elevation bearings 521 may all be provided to roll with respect to any one of the pair of elevation rail housings 520.

The remaining three of the six elevation bearings 521 may be provided on an opposite side of the other of the pair of elevation rail housings 520. The remaining three of the six elevation bearings 521 may all be provided to roll with respect to the other of a pair of elevation rail housings 520.

The pair of sliding rail housings 530 may be disposed on a lower side of each of the pair of elevation rail housings 520. The sliding rail housing 530 may be fixed (e.g., affixed) to the console housing 200.

A plurality of sliding bearings 531 may be provided. The plurality of sliding bearings 531 may be formed to roll with respect to each of a pair of sliding rail housings 530.

For example, six sliding bearings 531 are provided, and three of the six sliding bearings 531 may be provided on one side of any one of the pair of sliding rail housings 530. Three of the six sliding bearings 531 may all be provided to roll with respect to any one of the pair of sliding rail housings 530.

The remaining three of the six sliding bearings 531 may be provided on an opposite side of the other of the pair of sliding rail housings 530. The remaining three of the six sliding bearings 531 may all be provided to roll with respect to the other of the pair of sliding rail housings 530.

The elevation module 500 may further include an elevation bearing connection plate 522 that is connected to the three of the above-described six elevation bearings 521.

The elevation module 500 may further include a sliding bearing connection plate 532 that is connected to three of the six sliding bearings 531 described above.

The elevation rod 540 may include a first elevation rod 550 and a second elevation rod 560 that extends to cross the first elevation rod 550. A pair of first elevation rods 550 and a pair of second elevation rods 560 may be provided, respectively.

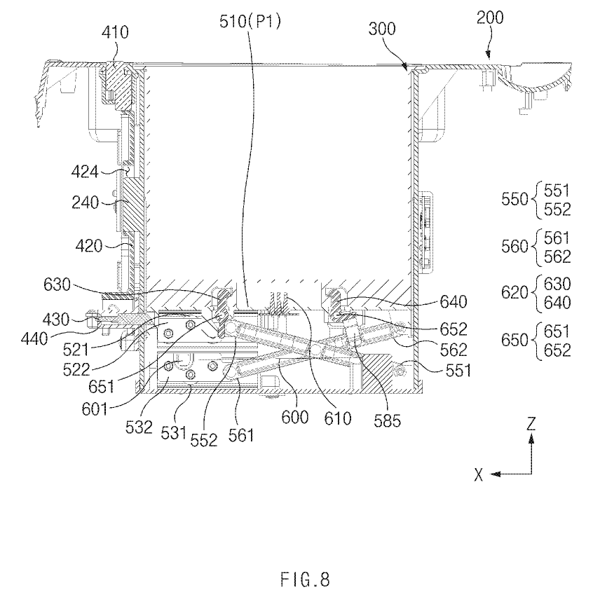

The first elevation rod 550 may include a first end portion 551 (see FIG. 8) that is rotatably fixed (e.g., affixed) to the console housing 200 and a second end portion 552 that is rotatable with respect to the first end portion 551 of the first elevation rod 550 to elevate the elevation rail housing 520.

The second elevation rod 560 may extend to cross the first elevation rod 550 at one point. The second elevation rod 560 may include a first end portion 561 that is formed to be slid with respect to the sliding rail housing 530 and a second end portion 562 that is rotatable with respect to the first end portion 561 and is coupled to the elevation plate 510.

The second end portion 552 of the first elevation rod 550 may be connected to the elevation bearing connection plate 522.

When the second end portion 552 of the first elevation rod 550 is rotated clockwise with respect to the first end portion 551 of the first elevation rod 550 when viewed in a state, in which it is spaced apart to one side (the “Y” direction) in the second direction, the elevation rail housing 529 may be elevated while the elevation bearing connection plate 522 is moved in a direction, in which it is extracted from the elevation rail housing 520. As the elevation rail housing 520 is elevated, an area of the elevation plate 510 may be elevated.

The first end portion 561 of the second elevation rod 560 may be connected to the sliding bearing connection plate 532. Accordingly, when the sliding bearing 531 rolls in a direction, in which it is extracted from the sliding rail housing 530, the sliding bearing connection plate 532 and the first end portion 561 of the second elevation rod 560 may be slid in a direction, in which they are extracted from the sliding rail housing 530.

Then, when viewed from one side (the “Y” direction) in the second direction, the second end portion 562 of the second elevation rod 560 may be rotated counterclockwise with respect to the first end portion 561 of the second elevation rod 560. Accordingly, an opposite area of the elevation plate 510 coupled to the second end portion 562 of the second elevation rod 560 may be elevated.

The elevation module 500 may further include a guide elastic member 600 that rotates the sliding bearing 531 so that the sliding bearing 531 rolls with respect to the sliding rail housing 530, and a fixing member 601 that is connected to the sliding bearing connection plate 532 while fixing the guide elastic member 600.

One end portion of the guide elastic member 600 may be fixed (e.g., affixed) to the console housing 200, and an opposite end portion of the guide elastic member 600 may be fixed (e.g., affixed) to the fixing member 601. The fixing member 601 is fixed (e.g., affixed) to the pair of sliding bearing connection plates 532 between the pair of sliding bearing connection plates 532, and may fix the opposite end portion of the guide elastic member 600.

The elastic member 600 may be, for example, a spring, a rubber band, a coil, etc. The guide elastic member 600 may be a leaf spring. Because the guide elastic member 600 is a leaf spring, an elastic force may be applied such that the opposite end portion of the guide elastic member 600 is moved toward the one end portion of the guide elastic member 600.

As illustrated in FIG. 5, when the guide stopper 430 interferes with (e.g., locks, latches to, etc.) the elevation plate 510, the elevation plate 510 may be located in a first position P1. In this case, the opposite end portion of the guide elastic member 600 may be moved toward the one end portion, but because the position of the elevation plate 510 is fixed (e.g., affixed) by the guide stopper 430, the elevation module 500 may be fixed (e.g., affixed). In this case, a crossing angle between the first and second elevation rods 550 and 560 may be a first angle θ1.

Thereafter, when the guide stopper 430 is extracted from (e.g., unlatches) the stopper groove 511, the opposite end portion of the guide elastic member 600 may be moved toward the one end portion of the guide elastic member 600, and the sliding bearing connection plate 532 and the first end portion 561 of the second elevation rod 560 that are connected to the guide elastic member 600 by the fixing member (e.g., bracket, frame, etc.) 601 may be moved toward the first end portion 551 of the first elevation rod 550.

Then, the second end portion 562 of the second elevation rod 560 may be elevated as the sliding bearing 531 rolls with respect to the sliding rail housing 530 due to the guide elastic member 600, and the second end portion 552 of the first elevation rod 550 may be elevated by the second elevation rod 560.

Then, as illustrated in FIG. 6, the elevation plate 510 may be located in a second position P2 that is a higher position than the first position P1. In this case, the crossing angle between the first elevation rod 550 and the second elevation rod 560 may be a second angle θ2. The second angle θ2 may be greater than the first angle θ1.

As described above, a pair of first elevation rod 550 and a pair of second elevation rods (e.g., axles) 560 may be provided to be spaced apart from each other and are parallel to each other, respectively.

The elevation module 500 includes a pair of first elevation rods 550, a rod interlocking shaft 570 that connects the pair of first elevation rods 550, a pair of first elevation rods 550, a first rod connection shaft 580 that connects the pair of elevation bearing connection plates 522, a pair of second elevation rods 560, and a second rod connection shaft 590 that connects the pair of sliding bearing connection plates 532.

More specifically, the rod interlocking shaft 570 may connect the pair of first elevation rods 550 and the pair of second elevation rods 560 at one crossing point between the first elevation rods 550 and the second elevation rods 560.

The first rod connection shaft 580 may connect the second end portions 552 of the pair of first elevation rods 550 and the pair of elevation bearing connection plates 522. The first rod connection shaft 580 may connect the pair of first elevation rods 550.

The second rod connection shaft 590 may connect the first end portions 561 of the pair of second elevation rods 560 and the pair of sliding bearing connection plates 532. The second rod connection shaft 590 may connect the pair of second elevation rods 560.

The elevation module 500 may include a rod interference shaft 585 that is connected to the pair of second elevation rods 560 between the rod interlocking shaft 570 and the second end portions 562 of the pair of second elevation rods 560. The rod interference shaft 585 may connect a pair of second elevation rods 560 at a point that is distinguished from the second rod connection shaft 590.

The elevation module 500 may include a locking boss 620 that is rotatably coupled to the elevation plate 510 and protrudes upward (the “Z” direction) from the elevation plate 510. The locking boss 620 may be formed to fix the console module 300.

The locking boss 620 may include a first locking boss 630 that is formed to interfere with the first rod connection shaft 580, and a second locking boss 640 that is formed to be spaced apart from the first locking boss 630 and to interfere with the rod interference shaft 585.

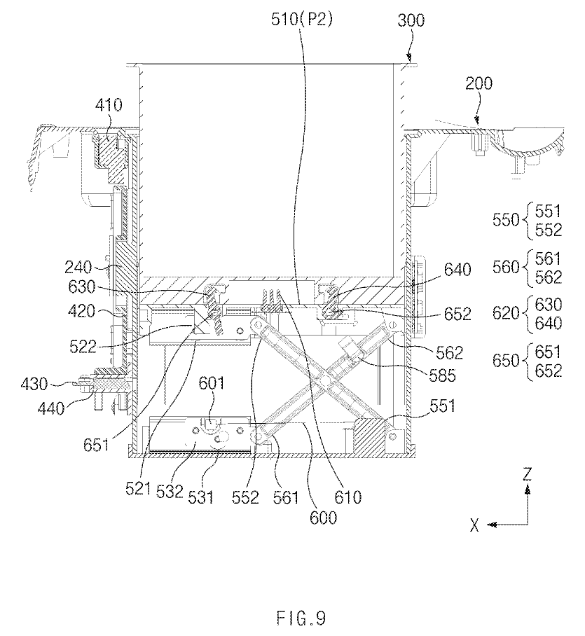

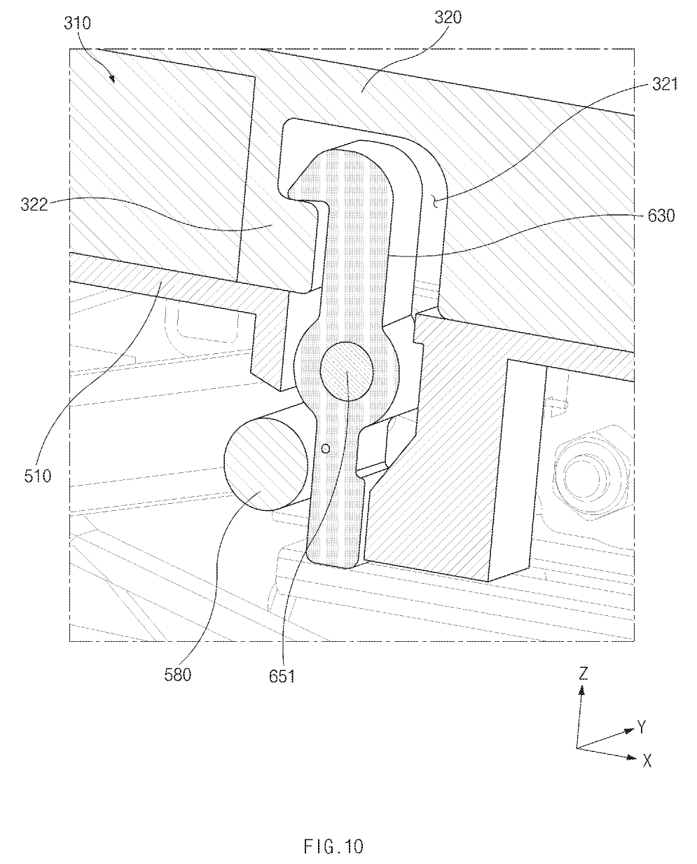

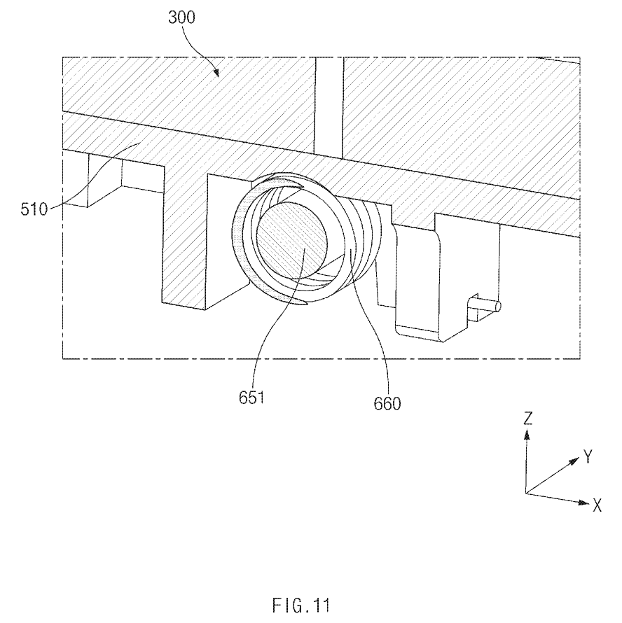

FIG. 8 is a longitudinal cross-sectional view of a console of a vehicle when an elevation plate is located in a first position. FIG. 9 is a longitudinal cross-sectional view of a console of a vehicle when an elevation plate is located in a second position. FIG. 10 is a cross-sectional perspective view of a first locking boss, a first boss rotation shaft, an elevation plate, and a console module when the first locking boss is inserted into a locking boss groove. FIG. 11 is a cross-sectional perspective view of a first boss rotation shaft, a coil spring member, an elevation plate, and a console module.

Referring to FIGS. 8 to 11, when the push button 410 is pressed downward, the push rod 420 may be pressed downward. In order to guide the downward sliding of the push rod 420, the console housing 200 may include a rod guide boss 240 that protrudes to pass through the push rod 420.

Correspondingly, the push rod 420 may define a rod through-hole 424, through which the rod guide boss 240 passes. A height of the rod through-hole 424 in an upward/downward direction may be formed to be greater than a height of the rod guide boss 240 in the upward/downward direction.

According to this structure, the push rod 420 that is pressed downward by the push button 410 may be slid only downward while contacting an outer surface of the console housing 200.

When the push rod 420 is slid downward, the guide stopper 430 may interfere with the locking inclined surface 423 (see FIG. 3) of the push rod 420 and may be moved to become more distant from the elevation plate 510.

When the guide stopper 430 is spaced apart from the elevation plate 510, an elastic force is added by the guide elastic member 600 so that the first elevation rod 550 and the second elevation rod 560 may be moved such that the crossing angle thereof becomes larger.

The first elevation rod 550 may be rotated so that the second end portion 552 of the first elevation rod 550 is raised with respect to the first end portion 551 of the first elevation rod 550, and the second elevation rod 560 may be rotated so that the second end portion 562 of the second elevation rod 560 is raised as the first end portion 561 of the second elevation rod 560 is slid toward the first end portion 551 of the first elevation rod 550.

The elevation plate 510 may be elevated to pop up by the first elevation rod 550 and the second elevation rod 560. A first locking boss 630 and a second locking boss 640 may be provided in the elevation plate 510.

The console module housing 310 that is elevated by the elevation plate 510 may include a module base 320 that contacts the elevation plate 510. The module base 320 may define a locking boss groove 321, into which the locking boss 620 is inserted.

A pair of locking boss grooves 321 may be provided such that the first and second locking bosses 630 and 640 may be inserted into the pair of locking boss grooves 321, respectively.

The elevation module 500 may include a boss rotation shaft 650 that rotatably couples the locking boss 620 to the elevation plate 510 and a coil spring member 660 that extends to surround the boss rotation shaft 650 to apply an elastic force to the locking boss 620. The coil spring member 660 may be a coil spring. The coil spring member 660 may be disposed adjacent to the boss rotation shaft 650.

A pair of boss rotation shafts 650 may be provided. The pair of boss rotation shafts 650 may include a first boss rotation shaft 651 that rotatably couples the first locking boss 630 to the elevation plate 510 and a second boss rotation shaft 652 that rotatably couples the second locking boss 640 to the elevation plate 510.

Furthermore, a pair of coil spring members 660 may be provided. One of the pair of coil spring members 660 may apply an elastic force to the first locking boss 630 against the elevation plate 510, and the other of the pair of coil spring members 660 may apply an elastic force to the second locking boss 640 against the elevation plate 510.

When the elevation plate 510 is located in the first position P1, the first locking boss 630 may interfere with the first rod connection shaft 580, and the second locking boss 640 may interfere with the rod interference shaft 585.

Accordingly, in spite that the first locking boss 630 and the second locking boss 640 may be rotated by the boss rotation shaft 650 as an electric force is applied thereto by the coil spring member 660, rotation thereof may be stopped by the first rod connection shaft 580 and the rod interference shaft 585.

In this case, the first locking boss 630 and the second locking boss 640 may be inserted into the pair of locking boss grooves 321 and may be fixed (e.g., affixed) in a position, in which they are stopped by a locking stop (also referred to as a locking stopping part) 322.

When the first locking boss 630 and the second locking boss 640 are inserted into the locking boss groove 321 and are stopped by the locking stop 322, the position of the console module 300 may be fixed (e.g., affixed).

When the elevation plate 510 is elevated to the second position P2, the first locking boss 630 may be spaced apart from the first rod connection shaft 580, and the second locking boss 640 may be spaced apart from the rod interference shaft 585.

Accordingly, the first locking boss 630 and the second locking boss 640 may be rotated by the coil spring member 660, so that the first locking boss 630 and the second locking boss 640 may be extracted from the locking boss groove 321.

Accordingly, the console module 300 may be raised from the elevation plate 510. That is, the console module 300 may be replaced from the console housing 200.

Meanwhile, when the guide stopper 430 releases interference with the elevation plate 510 according to the above-described principle, the elevation plate 510 and the locking boss 620 may be sequentially moved due to the elastic force of the guide elastic member 600, and the console module 300 may instantly pop up upward.

Meanwhile, the elevation module 500 may further include one or more pin connectors (also referred to as a pin connection part) 610 that is disposed between the first locking boss 630 and the second locking boss 640 and passes through the elevation plate 510 to protrude toward the console module 300. The pin connectors 610 may be a pogo pin.

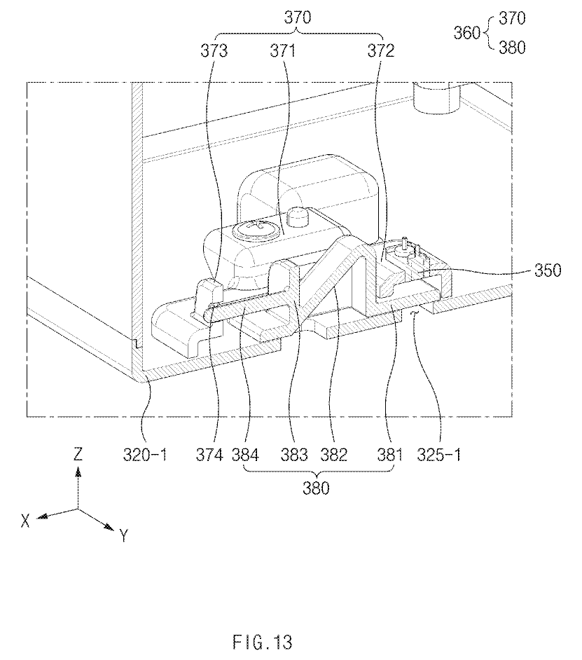

Although FIGS. 8 and 9 do not separately illustrate a pin contact that is connected to the one or more pin connectors 610 of the console module 300, one or more pin contacts (also referred to as electrical contacts, contact pads, pin receptacles, or pin connector receptacles) 350 (see FIG. 13) of the console module 300 that will be described later may be provided in the module base 320.

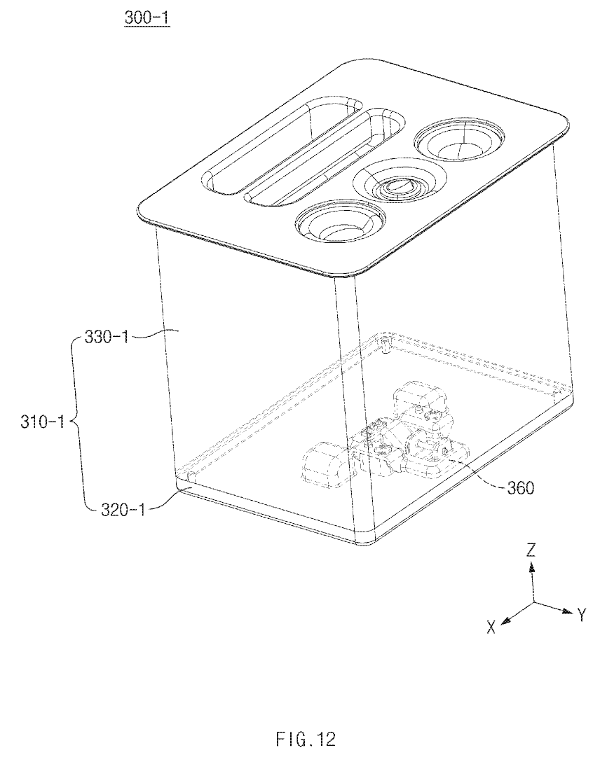

FIG. 12 is a perspective view of a console module. FIG. 13 is a cross-sectional perspective view of a module base, a pin contact, and a pin cover part (also referred to as a pin cover) of a console module.

Referring to FIGS. 12 and 13, a console module 300-1 may include a console module housing 310-1 that is inserted into the reception space 210 (see FIG. 2).

The console module 300-1 may be provided as a speaker. The console module housing 310-1 may include a module base 320-1, and a module housing member 330-1 that is coupled to the module base 320-1.

The console module 300-1 may include one or more pin contacts (e.g., electrical contacts, contact pads, pin receptacles, or pin connector receptacles) 350 that are configured to be connected to the one or more pin connectors 610 (see FIG. 9). The one or more pin contacts 350 may be configured such that the one or more pin connectors 610 may be inserted thereinto, and when the one or more pin contacts 350 and the one or more pin connectors 610 are connected to each other, the console module 300-1 may receive electric power through the one or more pin connectors 610.

More specifically, the module base 320-1 of the console module housing 310-1 may define a pin through-hole 325-1, through which the one or more pin connectors 610 pass.

The console module 300-1 may include a pin cover part 360 that is fixed (e.g., affixed) to the console module housing 310-1 and supports the one or more pin contacts 350. The pin cover part 360 may cover the one or more pin connectors 610 between the one or more pin contacts 350 and the one or more pin connectors 610. The pin cover part 360 may include a cover bracket 370 and a pin cover member 380.

The cover bracket 370 may be fixed (e.g., affixed) to the module base 320-1 of the console module housing 310-1 and may support the one or more pin contacts 350. The pin cover member 380 may be slid between a pin cover position, in which it is disposed between the one or more pin connectors 610 and the one or more pin contacts 350 to cover (e.g., block) the one or more pin connectors 610 (e.g., keep or block the one or more pin connectors 610 from making contact with the pin contacts 350), and a pin opening position, in which it is slid from the pin cover position with respect to the cover bracket 370 to open the pin through-hole 325-1 (e.g., the one or more pin contacts 350 are exposed through the pin through-hole 325-1).

The cover bracket 370 may include a bracket area 371, a pin support area 372, and a boss guide area 373.

The bracket area 371 may be fixed (e.g., affixed) to the console module housing 310-1. The pin support area 372 may protrude upward from the bracket area 371 and may support the one or more pin contacts 350.

The boss guide area 373 may protrude upward from the bracket area 371 such that the pin cover member 380 is disposed between the boss guide area 373 and the pin support area 372. The boss guide area 373 may define a through-hole 374 that passes from one side that faces the pin support area 372 to an opposite side that faces an opposite side of the pin support area 372.

The pin cover member 380 may include a sliding cover area 381, a sliding interference (e.g., stop) area 382, a sliding protrusion area 383, and a guide boss area 384.

The sliding cover area 381 may be an area that contacts the module base 320-1. The sliding cover area 381 may be formed to cover one or more pin connectors 361 between the one or more pin contacts 350 and the one or more pin connectors 610 while the sliding thereof is guided by the bracket area 371.

The sliding interference area 382 may protrude upward from the sliding cover area 381. The sliding interference area 382 may be formed to interfere with (e.g., stop, catch, etc.) the pin support area 372.

The sliding protrusion area 383 may protrude from the sliding cover area 381 to one side of the sliding interference area 382.

Because the sliding interference area 382 and the sliding protrusion area 383 protrude upward from the sliding cover area 381, they may be operated by the user.

The guide boss area 384 may be an area that protrudes from the sliding protrusion area 383 and is inserted into the through-hole 374. The guide boss area 384 may be slid only in one direction with respect to the boss guide area 373 while being inserted into the through-hole 374.

Accordingly, the guide boss area 384 may be slid in one direction by the boss guide area 373, so that the pin cover member 380 may be slid only to opposite sides in one direction.

According to the above principle, the pin cover member 380 may be slid between the pin cover position, in which the pin through-hole 325-1 is closed, and the pin opening position, in which the pin through-hole 325-1 is opened.

When the pin cover member 380 is disposed in the pin cover position, the sliding interference area 382 may contact the pin support area 372 to serve as a kind of stopper.

When the pin cover member 380 is disposed in the pin opening position, the sliding protrusion area 383 may contact the boss guide area 373 to serve as a kind of stopper.

Accordingly, due to this structure, when the one or more pin connectors 610 and the one or more pin contacts 350 are not connected to each other, the one or more pin connectors 610 may be prevented from being exposed to the outside. Accordingly, it is possible to improve the sealing performance of the one or more pin connectors 610 to water, and the durability of the one or more pin connectors 610 from the damage to the one or more pin connectors 610, and the like.

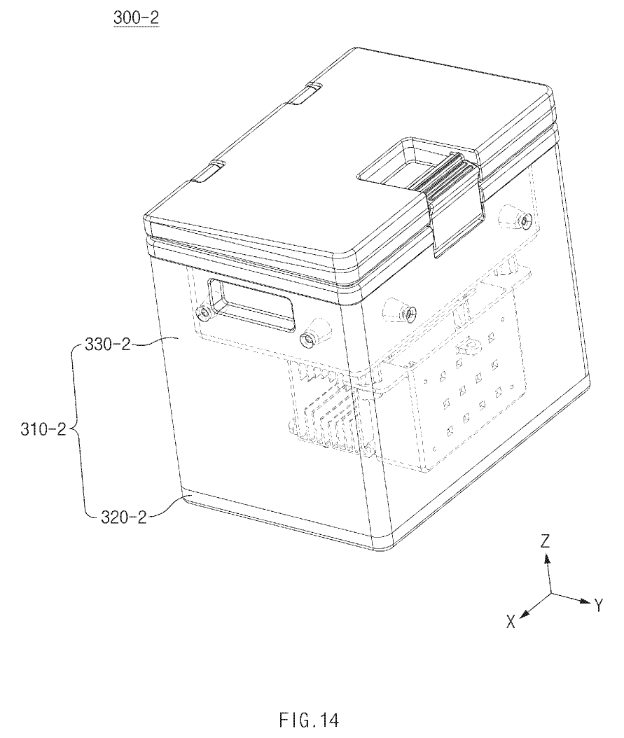

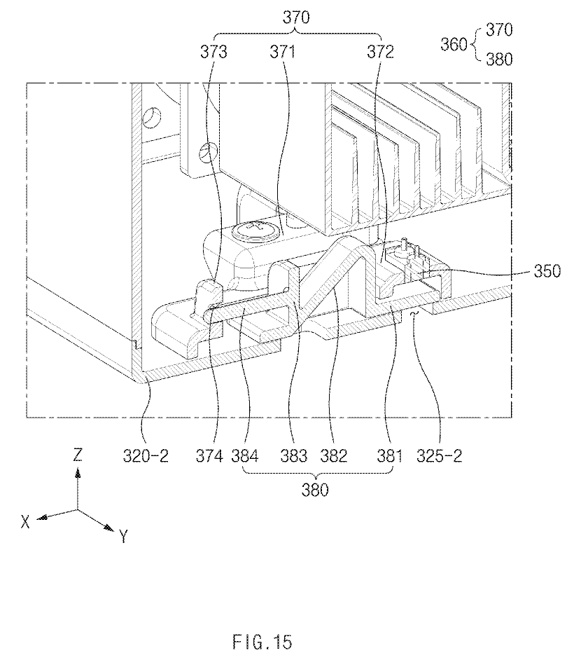

FIG. 14 is a perspective view of a console module. FIG. 15 is a cross-sectional perspective view of a module base, a pin contact, and a pin cover part of a console module.

Referring to FIGS. 14 and 15, a console module 300-2 may include a console module housing 310-2 that is inserted into the reception space 210 (see FIG. 2).

The console module 300-2 may be provided as a refrigerator. The console module housing 310-2 may include a module base 320-2, and a module housing member 330-2 that is coupled to the module base 320-2.

The console module 300-2 provided as a refrigerator may also include one or more pin contacts 350 to receive electric power. For a description of the structure and principle of the pin through-hole 325-2, the one or more pin contacts 350, and the pin cover part 360, the description of the structure or principle of the pin through-hole 325-1, the one or more pin contacts 350, and the pin cover part 360.

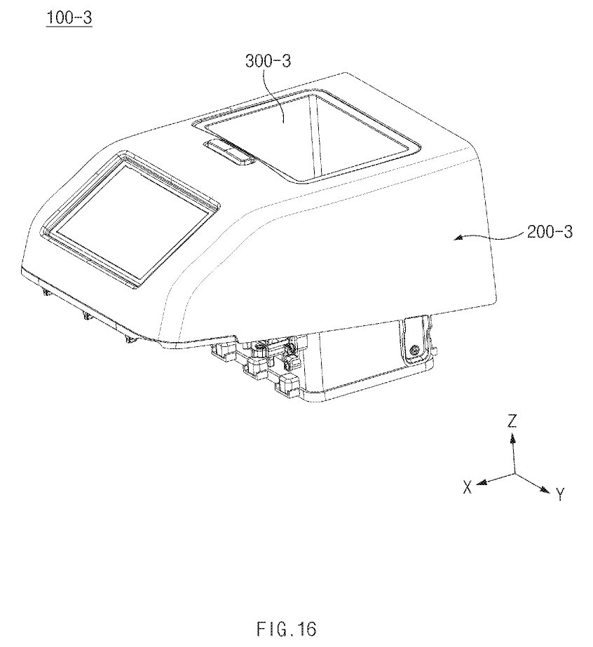

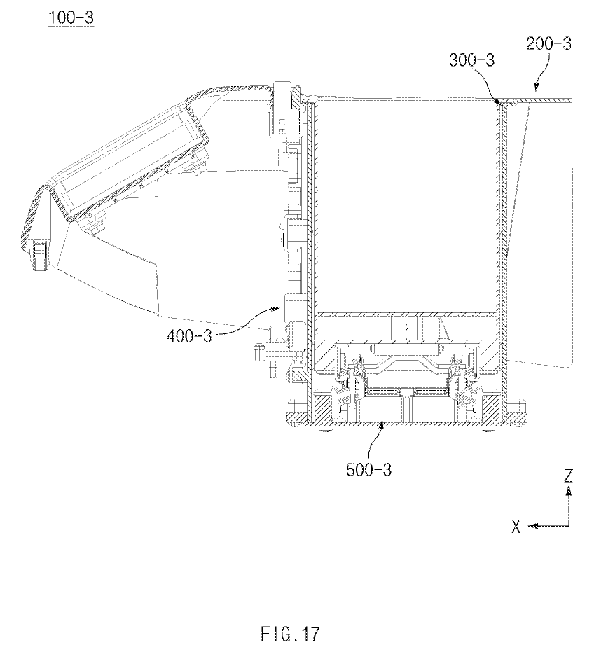

FIG. 16 is a perspective view of a console of a vehicle. FIG. 17 is a longitudinal cross-sectional view of a console of a vehicle.

Referring to FIGS. 16 and 17, a console 100-3 for a vehicle may include a console housing 200-3, a console module 300-3 that is detachably attached to the console housing 200-3, an elevation module 500-3 that elevates the console module 300-3, and a guide module 400-3 that guides the elevation of the elevation module 500-3.

The console module 300-3 of the console 100-3 for a vehicle may have a structure that is different from that of the console modules 300, 300-1, and 300-2 described above to perform a multipurpose function.

For a description of the console housing 200-3, the guide module 400-3, and the elevation module 500-3 of the console 100-3 for a vehicle, the description of the structure of the console housing 200, the guide module 400, and the elevation module 500 of the console 100 for a vehicle may be used.

However, two guide modules 400-3 of the console 100-3 for a vehicle may be provided, and accordingly, two guide stoppers 430 (see FIG. 3) and two stopper grooves 511 may be provided.

Furthermore, the console module 300-3 of the console 100-3 for a vehicle may have a pin cover part 360 (see FIG. 13), but the console module 300-3 may not have a pin cover part 360 when electric power is not required.

According to an aspect of the present disclosure, a console for a vehicle may include a console housing defining a reception space, a console module detachably attached to the console housing, and inserted into the reception space, a guide module including a press switch supported to be movable with respect to the console housing and a locking rod that interferes with the press switch to be lowered as the press switch is pressed, and an elevation module provided in an interior of the console housing, disposed on a lower side of the console module, and that elevates the console module as the locking rod is lowered.

The elevation module may include an elevation plate provided in an interior of the console housing, an elevation rail housing disposed on a lower side of the elevation plate, and configured to elevate the elevation plate, an elevation bearing provided on a side of the elevation rail housing, and configured to roll with respect to the elevation rail housing, and an elevation rod configured to rotate the elevation bearing to elevate the elevation rail housing.

The elevation module may further include a sliding rail housing fixed to the console housing and disposed on a lower side of the elevation rail housing, a sliding bearing provided on a side of the sliding rail housing and configured to roll with respect to the sliding rail housing, and a guide elastic member that rotates the sliding bearing such that the sliding bearing rolls with respect to the sliding rail housing and fixed to the console housing.

The elevation rod may include a first elevation rod including a (1-1)-th end portion fixed to the console housing to be rotatable and a (1-2)-th end portion being rotatable with respect to the (1-1)-th end portion to elevate the elevation rail housing, and a second elevation rod including a (2-1)-th end portion extending to cross the first elevation rod at a point and formed to be slid with respect to the sliding rail housing and a (2-2)-th end portion being rotatable with respect to the (2-1)-th end portion and coupled to the elevation plate.

The (2-2)-th end portion of the second elevation rod may be elevated by the guide elastic member, and the (1-2)-th end portion of the first elevation rod may be elevated by the second elevation rod.

A plurality of elevation bearings may be provided, and the elevation module may further include an elevation bearing connection plate connected to the plurality of elevation bearings, and a first rod connection shaft connecting the elevation bearing connection plate and the first elevation rod.

A plurality of sliding bearings are provided, and the elevation module may further include a sliding bearing connection plate connected to the plurality of sliding bearings, and a fixing member connected to the sliding bearing connection plate and that fixes the guide elastic member.

The guide elastic member may include a first end portion fixed to the console housing and a second end portion fixed to the fixing member, and the guide elastic member may include a leaf spring.

The elevation module may further include a second rod connection shaft connecting the second elevation rod and the sliding bearing connection plate.

The elevation module may further include a locking boss coupled to be rotatable with the elevation plate, and configured to protrude upward from the elevation plate to fix the console module.

The console module may include a console module housing inserted into the reception space, and the console module housing may define a locking boss groove formed such that the locking boss is inserted into the locking boss groove.

The elevation module may further include a boss rotation shaft coupling the locking boss such that the locking boss is rotatable with respect to the elevation plate, and a coil spring member disposed adjacent to the boss rotation shaft and that applies an elastic force to the locking boss.

A pair of first elevation rods and a pair of second rods may be provided to be spaced apart from each other and are parallel to each other, respectively, the elevation module may further include a first rod connection shaft connecting the pair of first elevation rods, a second rod connection shaft connecting the pair of second elevation rods, and a rod interference shaft connecting the pair of second elevation rods at a point distinguished from the second rod connection shaft, and the locking boss may further include a first locking boss configured to interfere with the first rod connection shaft, and a second locking boss spaced apart from the first locking boss, and configured to interfere with the rod interference shaft.

The guide module may further include a guide stopper passing through the console housing to interfere with the elevation plate, and that is moved between a locking position, in which a position of the elevation plate is fixed, and a release position, in which the locking rod is moved in a direction, in which the locking rod is extracted, to be released from interference with the elevation plate as the locking rod is lowered.

The guide stopper may include a guide stopper body passing through the console housing, and a guide stopper through-shaft protruding from the guide stopper body in a direction becoming more distant from the console housing, and the guide module may further include a stopper housing supported by the console housing and including a stopper hole, through which the guide stopper through-shaft passes

The console housing may include a rod guide boss protruding to pass through the locking rod, and the locking rod defines a rod through-hole, through which the rod guide boss passes.

The elevation module may further include a pin connection part passing through the elevation plate to protrude toward the console module, and wherein the console module may include a console module housing inserted into the reception space, and defining a pin through-hole, through which the pin connection part passes, a pin connector receptacle that is connected to the pin connection part, and a pin cover part fixed to the console module housing, supporting the pin connector receptacle, and cover the pin connection part between the pin connector receptacle and the pin connection part.

The pin cover part may include a cover bracket fixed to the console module housing and supporting the pin connector receptacle, and a pin cover member slid between a pin cover position, in which the pin connection part is covered between the pin connection part and the pin connector receptacle, and a pin opening position, in which the pin connection part is slid from the pin cover position with respect to the cover bracket to open the pin through-hole.

The cover bracket may include a bracket area fixed to the console module housing, a pin support area protruding upward from the bracket area and supporting the pin connector receptacle, and a boss guide area protruding upward from the bracket area to define a through-hole such that the pin cover member is disposed between the boss guide area and the pin support area, and the pin cover member may include a sliding cover area, sliding of which is guided by the bracket area, and configured to cover the pin connection part between the pin connector receptacle and the pin connection part, a sliding interference area protruding upward from the sliding cover area and configured to interfere with the pin support area, a sliding protrusion area protruding from the sliding cover area to a side of the sliding interference area, and a guide boss area protruding from the sliding protrusion area to be inserted into the through-hole, and sliding of which is guided by the boss guide area.

According to the present technology, because the console module of the console for a vehicle may be detachably coupled to the console housing, the console module may be customized and used, so that the convenience of the user may be improved.

In addition, according to the present technology, because the console module of the console for a vehicle may be elevated from the console housing by the guide module and the elevation module, the console module may be easily replaced, so that the convenience of the user may be improved.

In addition, according to the present technology, when the console module is coupled to the elevation plate, the locking boss may be inserted into the locking boss groove, and thus, the console module may be fixed, so that the convenience of the user may be improved.

In addition, according to the present technology, because the pin cover part may cover the pin connection part when the console module is coupled to the elevation plate and the pin connector and the pin contact are not connected to each other, the durability of the pin cover part may be improved.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, the example embodiment(s) of the present disclosure are intended not to limit but to explain the technical idea of the present disclosure, and the scope and spirit of the present disclosure is not limited by the above example embodiment(s). The scope of protection of the present disclosure should be construed by the attached claims, and all equivalents thereof should be construed as being included within the scope of the present disclosure.

What is claimed is:

1. A console of a vehicle, the console comprising:
a console housing having a reception space in an interior of the console housing;
a modular console detachably attached to the console housing and inserted into the reception space;
a latch assembly comprising:
a push button movably affixed to the console housing, and;
a push rod configured to, based on being pushed down by the push button, be lowered; and
a lift assembly provided in the interior of the console housing and disposed below the reception space, wherein the lift assembly is configured to, based on the push rod being lowered, elevate the modular console.

2. The console of claim 1, wherein the lift assembly comprises:
a plate provided in the interior of the console housing;
a first rail housing disposed below the plate and configured to elevate the plate;
one or more first bearings provided on a side of the first rail housing and configured to roll with respect to the first rail housing; and
one or more rods configured to rotate the one or more first bearings to elevate the first rail housing.

3. The console of claim 2, wherein the lift assembly further comprises:
a second rail housing affixed to the console housing and disposed below the first rail housing;
one or more second bearings provided on a side of the second rail housing and configured to roll with respect to the second rail housing; and
an elastic guide affixed to the console housing and configured to rotate the one or more second bearings such that the one or more second bearings roll with respect to the second rail housing.

4. The console of claim 3, wherein the one or more rods comprise:
a first rod comprising:
a first end portion affixed to the console housing to be rotatable; and
a second end portion being rotatable with respect to the first end portion of the first rod to elevate the first rail housing; and
a second rod comprising:
a first end portion extending to cross the first rod at a point and configured to slide with respect to the second rail housing; and
a second end portion being rotatable with respect to the first end portion of the second rod and coupled to the plate.

5. The console of claim 4, wherein the elastic guide is further configured to elevate the second end portion of the second rod, and
wherein the second rod is configured to elevate the second end portion of the first rod.

6. The console of claim 4, wherein the one or more first bearings comprise a plurality of first bearings, and
wherein the lift assembly further comprises:
a bearing connection plate connected to the plurality of first bearings; and
a first rod connection shaft connecting the bearing connection plate to the first rod.

7. The console of claim 4, wherein the one or more second bearings comprise a plurality of second bearings, and
wherein the lift assembly further comprises:
a second bearing connection plate connected to the plurality of second bearings; and
a bracket connected to the second bearing connection plate and configured to affix the elastic guide.

8. The console of claim 7, wherein the elastic guide comprises:
a first end portion affixed to the console housing and a second end portion affixed to the bracket, and
wherein the elastic guide comprises a leaf spring.

9. The console of claim 7, wherein the lift assembly further comprises:
a second rod connection shaft connecting the second rod to the second bearing connection plate.

10. The console of claim 2, wherein the lift assembly further comprises:
a locking boss coupled to be rotatable with the plate and configured to protrude upward from the plate to lock the modular console in place.

11. The console of claim 10, wherein the modular console comprises a modular console housing configured to be inserted into the reception space, and
wherein the modular console housing has a locking boss groove formed, on the modular console housing, to receive the locking boss.

12. The console of claim 10, wherein the lift assembly further comprises:
a boss rotation shaft coupled to the locking boss such that the locking boss is rotatable with respect to the plate; and
a coil spring disposed adjacent to the boss rotation shaft and configured to apply an elastic force to the locking boss.

13. The console of claim 10, wherein the one or more rods comprise a pair of first rods and a pair of second rods, wherein each of the pair of first rods is provided to be spaced apart from and is parallel to a corresponding one of the pair of second rods,
wherein the lift assembly further comprises:
a first rod connection shaft connecting the pair of first rods;
a second rod connection shaft connecting the pair of second rods; and
a rod interference shaft connecting the pair of second rods at a point distinguished from the second rod connection shaft, and
wherein the locking boss further comprises:
a first locking boss configured to be in contact with the first rod connection shaft; and
a second locking boss spaced apart from the first locking boss and configured to be in contact with the rod interference shaft.

14. The console of claim 2, wherein the latch assembly further comprises:
a latch configured to pass through the console housing to engage the plate and configured to move between a lock position, at which a position of the plate is fixed, and a release position, at which the push rod is lowered to disengage the latch from the plate.

15. The console of claim 14, wherein the latch further comprises:
a latch body passing through the console housing; and
a latch through-shaft protruding from the latch body and away from the console housing, and
wherein the latch assembly further comprises:
a latch housing supported by the console housing having a hole through which the latch through-shaft passes.

16. The console of claim 1, wherein the console housing comprises:
a rod guide boss protruding to pass through the push rod, and
wherein the push rod has a rod through-hole through which the rod guide boss passes.

17. The console of claim 2, wherein the lift assembly further comprises:
a pin connector passing through the plate to protrude toward the modular console, and
wherein the modular console comprises:
a modular console housing configured to be inserted into the reception space and having a pin through-hole through which the pin connector passes;
a pin contact configured to be connected to the pin connector; and
a pin cover assembly affixed to the modular console housing and disposed between the pin contact and the pin connector, wherein the pin cover is configured to support the pin contact and cover the pin contact.

18. The console of claim 17, wherein the pin cover assembly comprises:
a cover bracket affixed to the modular console housing and supporting the pin contact; and
a pin cover configured to slide, with respect to the cover bracket, between:
a first position, between the pin connector and the pin contact, at which the pin cover covers the pin contact, and
a second position at which the pin contact is exposed through the pin through-hole.

19. The console of claim 18, wherein the cover bracket comprises:
a bracket portion affixed to the modular console housing;
a pin support portion protruding upward from the bracket portion and supporting the pin contact; and
a boss guide portion protruding upward from the bracket portion and having a through-hole such that the pin cover is disposed between the boss guide portion and the pin support portion, and
wherein the pin cover comprises:
a sliding cover portion configured to slide, while being guided by the bracket portion, to the first position to cover the pin contact;
a sliding interference portion protruding upward from the sliding cover portion and configured to be in contact with the pin support portion;
a sliding protrusion portion protruding from the sliding cover portion toward the sliding interference portion; and
a guide boss portion protruding from the sliding protrusion portion to be inserted into the through-hole and configured to slide while being guided by the boss guide portion.

20. A vehicle comprising:
a chassis; and
a console comprising:
a console housing having a reception space in an interior of the console housing;
a modular console detachably attached to the console housing and inserted into the reception space;
a latch assembly comprising:
a push button movably affixed to the console housing; and
a push rod configured to, based on being pushed down by the push button, be lowered; and
a lift assembly provided in the interior of the console housing and disposed below the reception space, wherein the lift assembly is configured to, based on the push rod being lowered, elevate the modular console.
